(19) United States
(12) Patent Application Publication
(10) Pub. No.: US 2011/0011192 A1
(43) Pub. Date: Jan. 20, 2011

(54) TRANSMISSION HAVING CONTINUOUSLY VARIABLE GEAR RATIOS BETWEEN AN INPUT SHAFT AND AN OUTPUT SHAFT

(76) Inventor: Edmund F NAGEL, Andelsbuch (AT)

Correspondence Address: YOUNG & THOMPSON, 209 Madison Street, Suite 500, Alexandria, VA, 22314, US

(21) Appl. No.: 12/922,586

(22) PCT Filed: Mar. 23, 2009
(86) PCT No.: PCT/AT09/00099

§ 371 Date: Sep. 14, 2010

(30) Foreign Application Priority Data
Mar. 21, 2008 (AT) A 448/2008

(51) Int. Cl. F16H 29/04

(52) U.S. Cl. 74/117

(57) ABSTRACT

Gear mechanism with a continuously variable gear ratio between an input shaft (1) and an output shaft (2), which has at least two pendulum arms (9) that are mounted to pivot around an axis (10) and that are offset into a uniform lifting motion (21) that alternately and mutually overlaps in the work cycles by the rotation of the input shaft (1) and the cam disks (7) that are connected to it in a form-fitting manner, and the arms convert by element of two adjusting parts (15) that can be moved along the pendulum arm adjustment path (20) or by element of two pendulum arms (15) that can be moved by the pendulum shaft (10) along the pendulum arm adjustment path (20) in the variable-length back-and-forth motion of the two gear mechanism elements (26), and this alternating motion is transmitted to the two couplings (27) that are dependent upon the direction of rotation, where it in turn converts into a continuous and uniform rotation of an output shaft (2), whereby each pendulum arm (15) under load is automatically canted for canting noses (18) in the pendulum arm pass-through (11) that are provided for this purpose.

Gear mechanism with a continuously variable gear ratio between an input shaft and an output shaft, which has at least two pendulum arms that are mounted to pivot around an axis and that are offset into a uniform lifting motion that alternately and mutually overlaps in the work cycles by the rotation of the input shaft and the cam disks that are connected to it in a form-fitting manner, and said arms convert by means of two adjusting parts that can be moved along the pendulum arm adjustment path in the variable-length back-and-forth motion of the two gear mechanism elements, and this alternating motion is transmitted to the two spatially remote couplings that are dependent upon the direction of rotation, where it in turn converts into continuous and uniform rotation of an output shaft.

So-called stepped gear mechanisms with continuous gear ratio adjustment are known and are shown in the most varied embodiments in the patent literature:

From U.S. Pat. No. 4,112,778, a gear mechanism that executes a continuously variable conversion between an input shaft and an output shaft is known. The problem of intermittent rotation on the output shaft is mitigated in this invention by a plurality of pendulum levers overlapping in their sinusoidal power transmission phases on the output shaft. Therefore, in each case, only a portion of the sine curve of power transmission to the output shaft is relayed in order to transmit the force of the next pendulum arm in the same way to the output shaft immediately. In this way, the intermittent rotation of the output shaft is no longer so strongly pronounced, and heavy vehicles can be driven by such a gear mechanism. It is, however, likewise unsuited for driving a light vehicle, such as, for example, a bicycle with its corresponding low inherent mass.

The Patent PCT/EP93/01771 shows a stepped gear mechanism, in which a ring is pushed around the input shaft by means of an adjusting hydraulic cylinder into a more or less pronounced eccentric position. The more vigorously the ring is pushed into an eccentric position, the more vigorously the pendulum arms that are arranged radially around the ring deflect in succession in an angularly offset manner. These partial rotations are transmitted to the individual output shaft via overrunning gears. Particularly in this design, the difficulty arises that rotation of the output shaft is not uniform, but rather takes place intermittently.

Therefore, this gear mechanism is likewise ill-suited for driving a light vehicle, such as, for example, a bicycle with its corresponding low inherent mass.

The invention U.S. Pat. No. 2,080,665 addresses the problem of intermittent rotation of the output shaft with a uniform rise of the multiple cam flanks. The intermittent rotation of the output shaft is to be avoided to the greatest extent possible. This can, however, only succeed in part since with the adjustment of the illustrated axial point of the pendulum arm, the setting angle of the sensing levers to these cams changes. Thus, the geometry of the cam flank to the sensing lever changes, and the original uniformity of a rotation again goes into intermittent rotation of the output shaft with the change of the transmission ratio. This stepped gear mechanism is likewise ill-suited for driving a light vehicle, such as, for example, a bicycle with its corresponding low inherent mass.

In addition to the problem of intermittent rotation of the output shaft that appears in all of the previously mentioned documents, U.S. Pat. No. 4,182,202 shows an adjustment of the suspension bearing of the push rods on the pendulum arm by means of linkages. In the representation shown, the workload correspondingly acts on the linkage via the bevel of the pendulum arm. If now such a stepped gear mechanism has to move, for example, a workload of 6,000 N (=real workload/bicycle), up to 3,000 N would act to such an extent on the linkage. This enormous adjusting load is only to prevail in stationary machines; in light vehicles, such as, for example, a bicycle, the adjusting load that is to be handled to such an extent on the adjusting element is too high by a multiple. Also, the adjustment of the suspension point of the push rods by means of rack and pinion and roller slip-in parts that is also proposed in a variant is not feasible for a light vehicle. In such vehicles, such as, for example, mountain bikes, the weight and the mechanical complexity play a very essential role. Weight and technical complexity are to be reduced to an absolute minimum. For driving a light vehicle, such as, for example, a bicycle, with 1.) its low inherent weight, 2.) the necessary filigree Bowden cables, 3.) the necessary low weight of the gear mechanism, and 4.) the necessarily low technical complexity, the use of this gear mechanism is ruled out.

The stepped gear mechanism that is shown in the laid-open specification DE 34 11 130 A1 eliminates the problem of the intermittent rotation of the output shaft. It is the curved pathway of a cam disk on which the pendulum arm is applied to run so that a linear course of an angle of rotation is provided. As a result, the uniform rotation of an input shaft is thus also converted into a uniform rotation on the output shaft. In the invention that is shown, however, a feasible solution to transfer the gear mechanism to a light vehicle is lacking. In addition, it is not possible to place the immense complexity of components on a light vehicle in a reasonable manner. The design is ill-suited because of its relatively complicated design and large number of components, as well as because of the lack of a feasibly convertible shift mechanism for, for example, the structural attachment to the bicycle.

The stepped gear mechanism for special bicycles shown in the laid-open specification DE 29 38 013 also exhibits the core problem of this continuous gear mechanism: it does not convert the uniform rotation of an input shaft into a uniform rotation of an output shaft but rather into an intermittent rotation. Around the input shaft, an eccentric disk is pushed into a more or less pronounced eccentric position. The more vigorously the eccentric disk is pushed, the more vigorously the pendulum arms that are arranged radially around the ring deflect in succession in an angularly offset manner. These partial rotations are transmitted by a ratchet gear mechanism to the individual output shaft. Particularly in this design, the difficulty occurs that the rotation of the output shaft is not uniform but rather takes place intermittently. Therefore, this gear mechanism for driving a light vehicle, such as a bicycle with its low inherent mass, is also ill-suited per se.

The German Patent DE 696 02 840 T2 also shows a similar gear mechanism for special bicycles and also has the core problem of most so-called stepped continuous gear mechanisms: it does not convert the uniform rotation of an input shaft into a uniform rotation of an output shaft but rather into an intermittent rotation. Around the input shaft, an eccentric ring is pushed into a more or less pronounced eccentric position. The more vigorously the eccentric ring is pushed, the more vigorously the three pendulum arms that are arranged radially around the ring deflect in succession in an angularly offset manner. These partial rotations are transmitted via a ratchet gear mechanism with internal toothing to the individual output shaft. Particularly with this design, the difficulty occurs that the rotation of the output shaft is not uniform, but rather takes place intermittently. This gear mechanism for driving a light vehicle, such as a bicycle with its correspondingly low inherent mass, is therefore also unsuitable per se.

Also known from the U.S. Pat. No. 5,603,240 is a stepped gear mechanism that has a cam disk and that prevents an intermittent rotation of the output shaft by appropriate profiling of the curved pathways. By means of the three pendulum arms that overlap in their action of the work cycle, a uniform and uninterrupted rotation of the drive shaft is achieved. In the representation shown, however, a feasible solution to transfer the gear mechanism to a light vehicle is lacking. Moreover, several gear overlaps are present in this gear mechanism, which are known to reduce efficiency to the extent that use on a bicycle has to be ruled out. Also here, it is not possible to install the immense complexity of components in a reasonable manner on a light vehicle. The design is ill-suited for, for example, adaption on a bicycle because of its relatively complicated design and large number of components, as well as because of the lack of a feasibly convertible shift mechanism and the reduced mechanical efficiency.

So-called “automatic gear mechanisms” or “electronic control systems for bicycle gear mechanisms” are known from the European Patents EP 0615 587 B1 and EP 0527 864 B1. The titles of the inventions suggest that because of such gear mechanisms without further assistance from the rider, an automatic switching of the gear ratio can be undertaken. This impression is utterly wrong since the electrically operated shift mechanism acts on a conventional bicycle chain gear mechanism. This can in no case switch automatically without the assistance of the rider since an “electronically” controlled shift not intended by the rider would have fatal results. If specifically the front erector on the large chain blades were activated under full throttle, the erector would be canted in the bicycle chain and destroyed or the chain would spring out. If, however, the rear gear shift caused a shift under full throttle that was not intended by the rider, the rider would abruptly stamp on the foot pedal “into empty space.” This probably would result in the rider falling. The designation “electronic” and “automatic” in this connection is thus misleading and not effectively fulfilled by the inventions.

The object of the invention is to provide a continuous gear mechanism of the above-mentioned type for use especially on bicycles. The gear mechanism is not to have any “gears,” but rather is to switch completely continuously. The basic requirement, however, is primarily that the rotation of the input shaft be converted absolutely uniformly into the rotation of the output shaft. It is also essential that the power transmission be carried out in a form-fitting or non-positive manner so that virtually no losses of friction occur. Consequently, any gear closure or especially friction closure between any components is to be avoided, and the efficiency of the gear mechanism should at least be equal to that of a conventional chain circuit. Moreover, the gear mechanism has to be designed quite simply in structure, on the one hand, and should only consist of a very few components. On the other hand, however, it also has to be very light and space-saving. The shift of the gear ratio has to take place with the usual thin Bowden cables or simple hydraulics and—in contrast to the conventional chain gear shifts of the bicycle—is also to be possible under load at any time of any shift of the gear ratio. This shift is normally to be handled by a small servomotor, which is fully automated by a cyclocomputer according to preset values in coordination with values of bicycle and rider sensors and is controlled without any direct assistance from the rider. The different force vectors for driving the vehicle, which occur because of the different angular position of the foot pedal to the rider's legs that are to bear the load, are to be compared by a dynamic gear ratio matching within a half-rotation of the foot pedal.

This object was achieved in that any pendulum arm under load is automatically canted for canting noses in the pendulum arm pass-through provided for this purpose. To adjust the gear ratio, the pendulum arms found in a back-and-forth motion that is uniform and mutually overlapping is pushed axially through the pendulum arm pass-through. Similar to screw clamps, the canting noses are canted automatically in a work cycle between the pendulum arm and the pendulum arm pass-through. They are thus canted automatically and immovably fixed in one another with the occurrence of a workload in the work cycle. Without any assistance from the user, the pendulum arm is thus automatically incorporated in an immovably fixed manner during any work cycle by the static friction with the pendulum arm pass-through.

As an alternative, the object can also be achieved in that movable adjusting parts are also canted non-positively on the respective immovable pendulum arm by the occurrence of a workload that is applied by the gear mechanism elements, and the adjusting parts are immovably fixed dynamically and automatically to the respective pendulum arm in such a way during the work cycle. Without any assistance from the user, the adjusting part is thus incorporated during any work cycle in an absolute non-positive manner and thus is loss-free with the pendulum arm. The greater the load on the gear mechanism element, the greater this non-positive connection is automatically and dynamically canted.

The non-positive connection between the adjusting part and pendulum arm is released with the elimination of the workload—thus during the return cycle—automatically and without further assistance at least to the extent that the respective adjusting part can move, if necessary, by means of a force far below the average tensile force that is transmitted by the adjusting part and directed longitudinally to the longitudinal axis of the pendulum arm. Normally and because of the design according to the invention, here, tensile forces with less than 10 kg are reached. Consequently, the customary thin, conventional Bowden cables can also be used, and primarily, it is immediately possible, particularly by this load, to adjust the gear ratio—during the return cycle—at will.

At each of the adjusting parts, the suspension point for the gear mechanism element—in one of the two directions to the longitudinal axis of the pendulum arm—is mounted far enough from the area within which the adjusting part is canted with the two tensile-force-loaded and opposing inside flanks on the pendulum arm. This operating principle is found in similar form in the conventional screw clamp of a carpenter. It cants the movable clip—in this case, however, the adjusting part—by a load that cants the adjusting part obliquely in a reliable non-positive connection, which is immediately released again with the elimination of the load. This canting and release of the non-positive connection takes place on any pendulum arm according to the invention up to more than 1,000 times per minute.

Because of an occurring workload, a pendulum arm is fixed immovably relative to the resulting force that acts upon it to the canting noses in the pendulum arm pass-through that are provided for this purpose. These forces are produced by the more or less pronounced deviation, resulting from the pendulum deflection, from the rectangular position of the pendulum arm to the tensile element. Particularly by this workload, for the duration of a load, the pendulum arm is immovably canted by this very load relative to the force subsequently acting on it for the respective pendulum arm pass-through and fixed in the adjusting noses. The greater the load on the gear mechanism element, the greater the locking static friction acts on the adjusting noses or on the pendulum arm.

The bicycle-control computer collects actual values as riding data of the bicycle or else physiological data on the bicycle rider with sensors, and in comparison against preprogrammed setpoint values, it automatically controls the adjusting element of the gear mechanism adjustment, if necessary, in a fully automated manner and without direct assistance from the bicyclist. The data that are collected from the sensors are, on the one hand, step frequency and speed, but, on the other hand, sensors also detect, e.g., heart rate, performance of the rider, etc. In comparing against preset data, such as, e.g., theoretical step frequency, theoretical heart rate, theoretical performance, etc., the computer readjusts the adjusting element automatically in an automated manner. A so-called fully automatic bicycle gear mechanism with an electronic control system without any limitation was thus provided for the first time. Without additional assistance from the rider, an automatic shift of the gear ratio is done. This shift is dependent only on the data that the cyclocomputer receives from the sensors and can immediately take place at any gear workload. An individual adjusting element can adjust the gear ratio by the alternately free mobility of the pendulum arm in the respective pendulum arm passage in the return cycle in any load. The adjusting element adjusts the gear mechanism according to the invention in a continuous and absolutely automatic manner without direct assistance from the bicyclist. An electronic system for controlling the servomotor can deal with an adjustment of the gear mechanism, that is, of course, significantly faster and more precise than any manual shift by the rider.

The adjustment of the length of the pendulum arm is carried out by means of a hydraulic, pneumatic or electric motor or else by means of Bowden cables. These adjusting elements produce a force vector, which is directed against a spring force of the return spring. In principle, various adjusting elements according to the invention are conceivable, such as, e.g.: electric servomotors that act directly on the pendulum arm or on the Bowden cable, pneumatic or hydraulic adjusting elements, whereby the pneumatic adjusting element can also be fed, e.g., from an on-board compressed air tank that can be filled manually. The adjusting Bowden cables can be controlled/adjusted by a servomotor or else also by an adjusting element that is to be operated manually.

The return spring also has the object of actively supporting the release of the canting between the pendulum arm and the pendulum arm passage during the return cycle. The spring is arranged in space in such a way that it produces a force between the components of the pendulum arm pass-through and the pendulum arm for the complete release of the canting, and said force is directed against the spring force for returning the coupling and the gear mechanism elements. By this spring force that is directed against the spring force for coupling return in the pendulum arm, a force vector is thus produced that is greater than that which is present at the gear mechanism elements in the return cycle. As a result, the canting between pendulum arm and pendulum arm pass-through is completely released in the return cycle, and the pendulum arm is pushed toward the sliding part in the pendulum arm passage.

The pendulum arms are applied to one separate pendulum shaft each. The sensing arms and thus the sensing rollers, which are offset radially by one-half sine length or one and one-half, or two and one-half, etc., of a cam disk, sit on these pendulum shafts.

This distance of one-half sine length makes it possible for the two rollers of the sensing arms to run together on an individual cam disk. With one-half sine length, the half of each length of a cam disk from UT to OT and in turn back to the next UT is meant. The offset by one-half sine length of a cam disk does not necessarily have to be on a cam; however, the offset can also be, for example, two cams with 1.5 sine intervals or 2.5., etc.

Relative to the rollers, the cam disk has a relatively low cam height in the area in which the longitudinal axis of the foot pedal forms the angle in the force vector of the rider's leg under load, where said angle is disadvantageous for the release of force. In the dynamic increase, it has, conversely, a maximum cam height in the area in which the longitudinal axis of the foot pedal forms the angle in the force vector of the rider's leg under load, where said angle is most advantageous for the release of force. When using the foot pedals, the rider can exert the lowest usable driving force on the OT or OT, caused by the angular position of the longitudinal axis of the foot pedal with regard to the force vector produced by it. To diminish or to smooth out the load imbalance resulting therefrom, in each case the gear ratio of the wheel rotation to the pedal rotation is reduced according to the invention by the dynamic cam flattening in the area of the UT or OT. This results ergonomically in a comparatively balanced load on the rider.

The adjustment path missed during an adjustment process, which cannot be passed on directly to the pendulum arm in a feasible adjustment path because of the alternating locking of the pendulum arm, is stored intermediately in a mechanical buffer element and in general is handled in the following return cycle by the corresponding pendulum arm. In a variant according to the invention, the Bowden cable sheaths have a sufficiently elastic crushability to represent the mechanical buffer element. In another variant according to the invention, the linkages have a sufficiently springy elasticity to represent the mechanical buffer element. If Bowden cables, for example, are used for the adjusting of the length of the pendulum arm, a buffer element is placed between or before the two Bowden cables, and said buffer element reversibly accommodates/stores the adjustment path during the reciprocal locking of an adjustment process. As soon as the canting of the pendulum arm is released, the latter is movable again, and the buffer element releases the adjustment pathway that was missed to the pendulum arm in question. If the Bowden cable sheaths have adequate elastic compression capacity, the latter or other mechanical buffer elements can be eliminated, since the adjustment path that cannot be taken up as an adjustment path on the pendulum arm compresses the Bowden cable sheath temporarily, which releases/takes up the above-mentioned adjustment path to the latter after the locked pendulum arm is released. If the Bowden cables have a sufficiently springy elasticity, other mechanical buffer elements can be eliminated, since the adjustment path that cannot be taken up on the pendulum arm temporarily extends the Bowden cables, which elastically takes up the stated adjustment path after the locked pendulum arm is released. As a mechanical buffer element, a star-shaped linkage can also be used, in which the single adjusting cable that exerts the adjusting pull is laterally offset in the middle, and the two links that run to the pendulum arm are laterally offset to feed the linkage point in the center of the star. By this star-shaped linkage of the links, it is achieved that the linkage between the locked link and the link that exerts tension from the servomotor is somewhat smoothed out/stretched in the sharp bend in the center of the star, and, consequently, the unlocked pendulum arm is adjusted somewhat more quickly.

Any one of the gear mechanism elements is a heavy-load spring element that is switched on intermediately and that begins to stretch in a load-dynamic and reversible manner starting from the occurrence of a specific heavy load, and the gear mechanism element is thus extended load-dynamically. This device quasi replaces the smallest gear ratios of the gear mechanism, since by stretching the heavy-load springs, the latter can allow less play to the free wheels. The energy that is then stored in the heavy-load spring is returned in a supportive manner to the latter in each case at the beginning of the overrun cycle to the next work cycle.

The load spring is deformed load-dynamically in the work cycle, and the spring force that is stored in such a way is released again in an efficient way in the next return cycle. On the tensile element in question, an efficient tension prevails on the coupling that is dependent upon the direction of rotation, although on the cam disk, the return of the pendulum arm has already begun. A path that was produced in the work cycle on the tensile element is thus not released completely on the wheel but rather stored in the spring to act as an additional force for driving the vehicle in the later return cycle. In this case, the characteristic of the steel springs accommodates very well the efficiency of such a device according to the invention, since these springs release approximately 100% of the energy stored as a deformation in their expansion and thus produce no lost energy—e.g., heat.

In a variant according to the invention, the load-dynamic spring element can be adjusted in its spring force from outside. Such a spring force adjustment can be achieved by, e.g., a hydraulic element, which increases or reduces the pretensioning of the spring element. The device of the heavy-load spring that can be adjusted in spring force could by itself already represent a simple load-dynamic continuous gear mechanism per se. This variant is included in the invention in question and could at any time exist separately, taken by itself. In this simple stepped gear mechanism, no additional adjustment devices would be necessary.

The coupling device that is dependent upon the direction of rotation consists of a rotationally symmetrical core, which is connected in a non-positive connection with the wheel hub and on which two clamping body free wheels are arranged axially beside one another, which in each case are encased by a rotationally symmetrical ring, and which in turn are both surrounded on the outside by a pinion gear or toothed belt disk and that are thus connected in a form-fitting manner. By the use of the clamping body free wheels that are known in the art and that are arranged axially beside one another on a rotationally symmetrical free-wheel core, a number of production steps are saved. By contrast, the ratchet free wheels, clamping ball free wheels, etc., do not require rotationally symmetrical components with significantly larger production expense. Moreover, by the application of the clamping body free wheels, not only does the production expense shrink, but the size of the coupling that is dependent upon the direction of rotation is reduced to the smallest conceivable degree. In addition, these clamping body free wheels have the advantage that, on the one hand, they close immediately at the beginning of the work cycle virtually without idling, and, on the other hand, they open again at the beginning of the overrun cycle without so-called “breaking force.”

In the method for operating a gear mechanism with a continuously variable gear ratio between an input shaft and an output shaft, it is specified that to reduce the weight and size of such a bicycle gear mechanism, each of the pendulum arms within a foot pedal rotation is to activate several, but if possible many deflections. This is possible by, if possible, many cams being provided on the driving cam disk. If, for example, a dozen cams are provided, an average cam height of less than 2 cm alone is sufficient to produce a length of stroke of the sensing arm, such that the latter breaks sufficient ground according to the invention and conversely does not apply an excessive load on it.

In addition, the method for operating a gear mechanism specifies that couplings that are dependent upon the direction of rotation are used, which can handle the high shift frequencies that are specific to the invention of, under certain circumstances, up to about 50 Hz (50 opening and closing processes/second) and with a connecting path of less than 3° of the rotation of the outside rings to the free-wheel core. This high operating frequency is a precondition that the gear mechanism can be reduced in weight. A doubling of the operating frequency means de facto conversely a halving of the load and thus also approximately a halving of the weight.

Couplings that are dependent upon the direction of rotation and that operate according to the invention are especially suitable when said couplings release the non-positive connection between the outside ring and the free-wheel core with no breaking force. The occurrence of breaking forces would often require return forces for the free-wheel gear mechanism that are high to impossible to achieve. There would thus be the danger that in the application of specific free-wheel designs, the function of locking that would disrupt the gear mechanism would occur for the reset.

To handle the requirements that are necessary according to the invention and to prevent a locking in the return cycle, as well as [being] switched to the necessarily high operating frequency of couplings that are dependent upon the direction of rotation, the so-called clamping body free wheels are suitable. These clamping body free wheels are the only known design to meet all of the requirements according to the invention in a first-rate manner.

Other advantages and details of the invention are explained below based on the embodiments of the invention that are depicted in the drawings. Here:

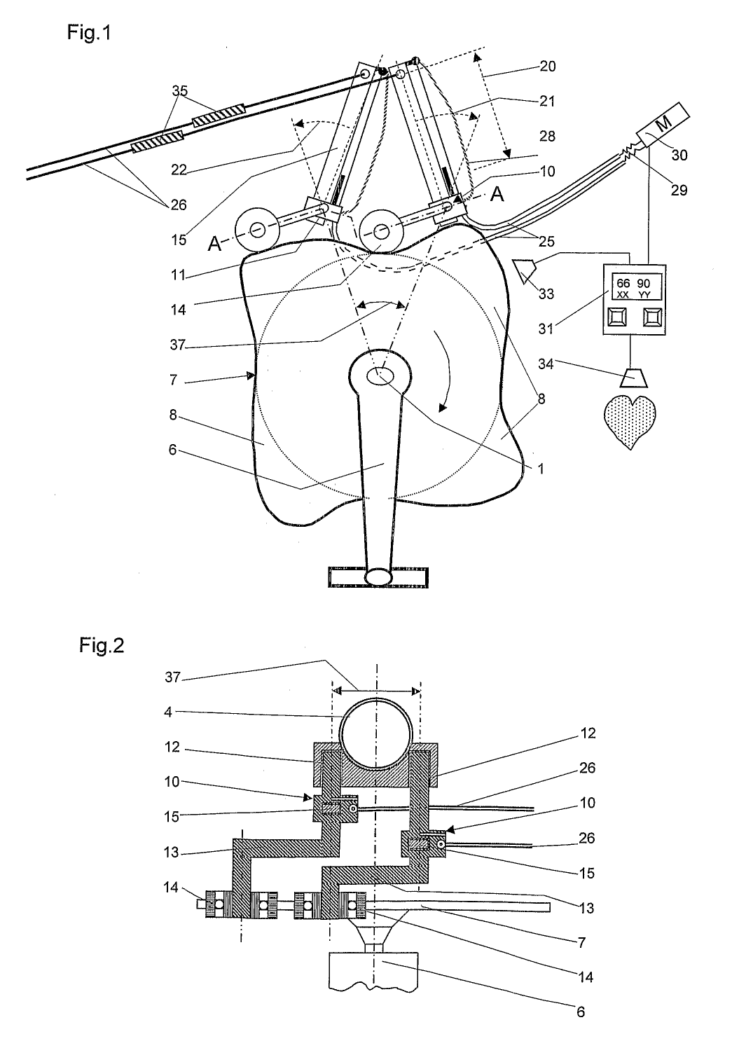

FIG. 1 shows a schematic representation of a side view of the gear mechanism with its individual cam disk and the two pendulum arm rollers that are offset radially around a half sine length of a cam disk as well as the adjustment with Bowden cables and the related electronic control.

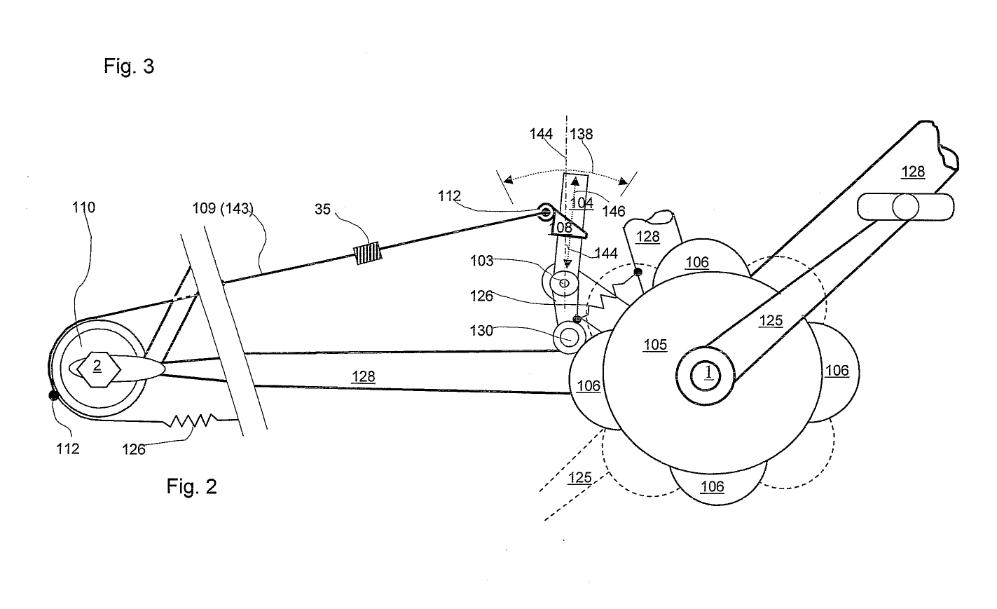

FIG. 2 shows the schematic section A—A/top view of FIG. 1.

FIG. 3 shows an alternative design to FIG. 1 with a schematic representation of a side view of the gear mechanism with a double cam disk.

FIG. 4 shows the section through the pendulum arm in its longest-possible setting and, in addition, the return spring for the pendulum arm and the heavy-load spring are shown. In this representation, the adjustment of the pendulum arm is carried out by way of example by means of Bowden cables.

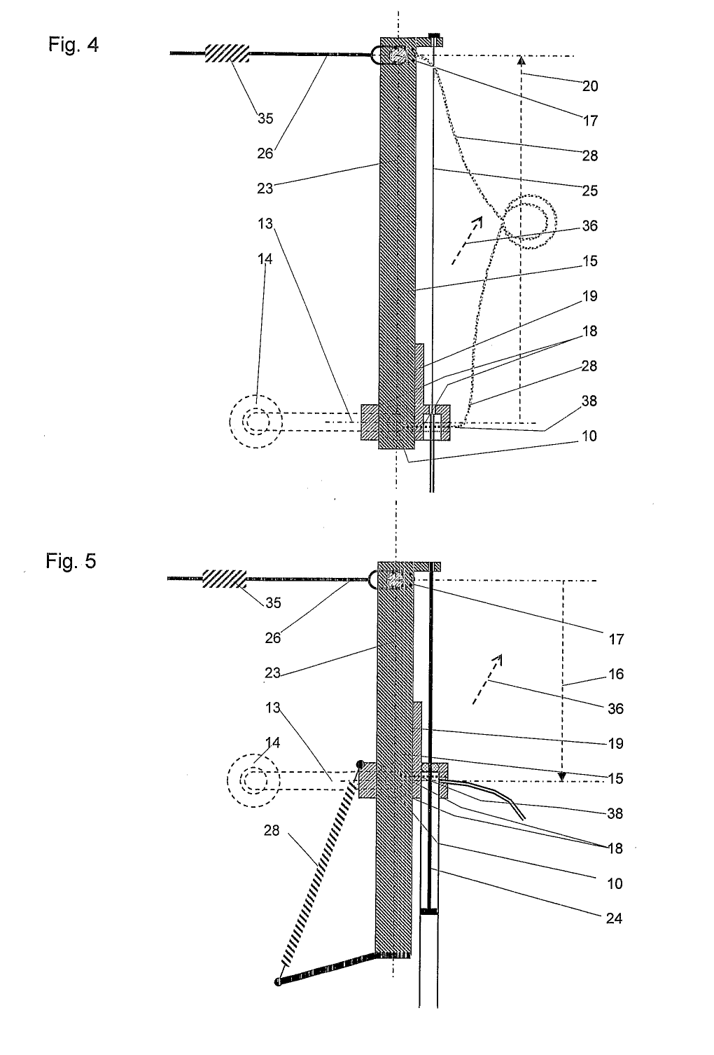

FIG. 5 also shows a section through the pendulum arm in an adjustment in which it is extended approximately in half. In this representation, the adjustment of the pendulum arm is carried out by way of example by means of hydraulic adjusting elements.

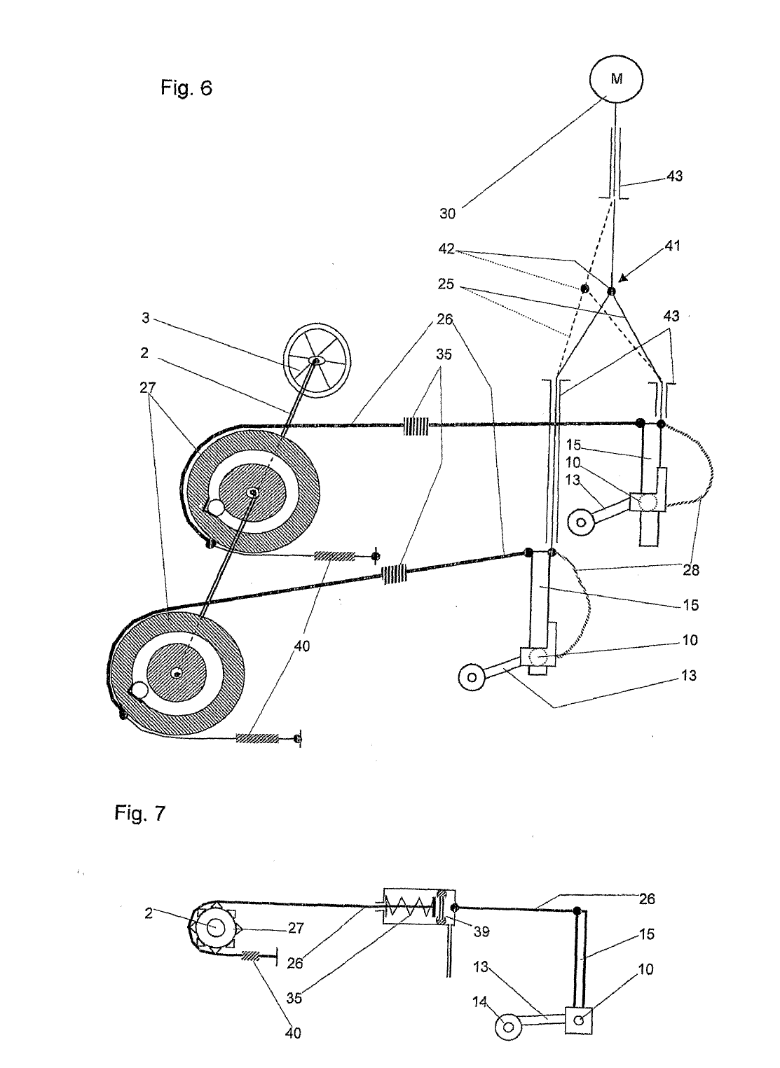

FIG. 6 shows the two pendulum arms in connection with an adjusting device in which the alternating temporary adjustable locking of a pendulum arm by the star-shaped circuit of the links is recovered/stored as a buffer element.

FIG. 7 shows a special application of the heavy-load spring with an adjusting device, which can change the pretensioning of the load-dynamic spring from outside during the driving operation.

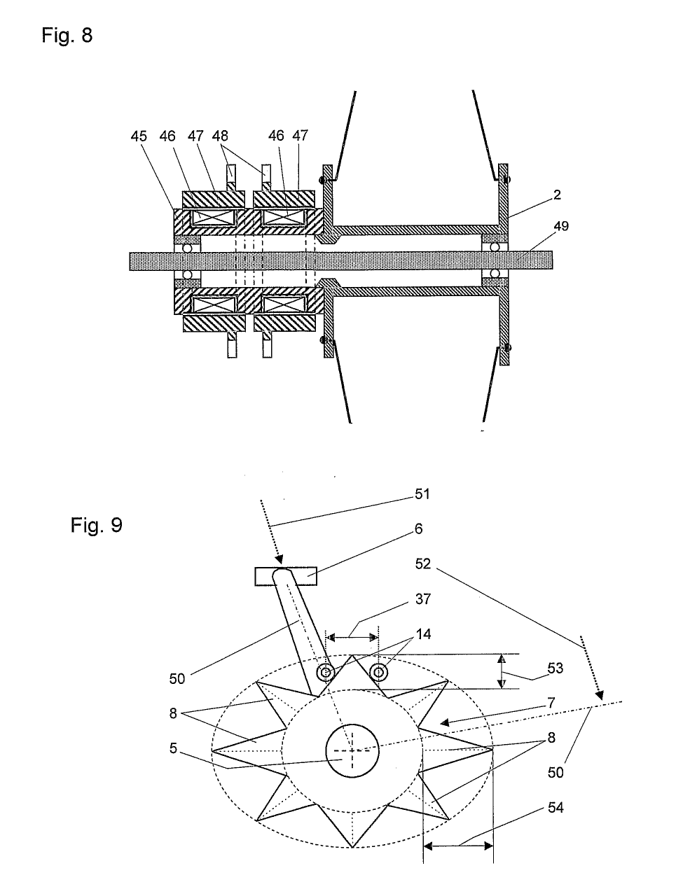

FIG. 8 shows a section through the coupling that is dependent upon the direction of rotation with the two clamping body free wheels and the section through the wheel hub.

FIG. 9 shows a schematic side view of the cam disk and the foot pedals for dynamic flattening or increase of the cam disks for the reduction of the gear ratio in the UT/OT range based on the pedal position.

In FIG. 1, a multi-cam cam disk 7 is shown, as well as the pendulum shafts 10 with the pendulum arm 15 that can thus be moved. In addition, the control of the pendulum arm adjustment via Bowden cables 25 is shown, and their servomotor 30 adjustment and its control by an on-board computer 31, which readjusts the actual values determined by the sensors 33, 34 relative to a target position by adjusting the gear ratio.

The number of cams 8 is depicted in the drawing as four. Normally, however, about a dozen of these cams 8 are arranged to limit, on the one hand, the individual cam of the sensing arm 13 to a reasonable measurement (<20 mm) with, at the same time, a load that can be handled mechanically on the sensing arm 13 or the sensing arm roller 14. If this load remains, as achieved according to the invention, the smallest standard load roller bearing 14 can be used.

In addition, the shape of the cam 8 shows that the rising slope of the work cycle is significantly longer that the falling slope of the return cycle—the work cam 21 thus occupies a larger angular segment than the overrun cycle 22. The cause for this lies in that the work cycles 21 have to overlap on the uninterrupted action on the blade wheel 3 or the back stops 27—one work cycle 21 is thus still active when the other 21 just begins to become active.

In the arrangement of the pendulum arm shafts 10, it can be seen that the latter are radially offset to one another. The interval in the representation that is shown is a one-half sine length of a cam 8. As a result, a second cam disk 7 can be eliminated since a cam 8 that activates the sensing arm 13 is already located at the correct interval corresponding to the next sensing arm 13 or the next sensing arm roller 14.

The pendulum arm 15 that is shown in the position of the fastest gear can be adjusted downward—pulled from this position by the Bowden cables 25. The return of the pendulum arm 15 is conversely carried out by a return spring 28.

The Bowden cables 25 are adjusted, if necessary, parallel through the electric servomotor 30. This servomotor 30 could be replaced in principle, of course, also by, for example, a pneumatic adjusting element or else by a simple, manual adjusting mechanism.

The cyclocomputer 31 controlled by the servomotor 30 is programmed by the rider to a specific setpoint value. Such a setpoint value can be, for example, the step frequency. In the sensor 33, the cyclocomputer 31 constantly measures the actual value: if the value is now below the theoretical value, for example, the cyclocomputer 31 turns back the gear ratio of the gear mechanism with the servomotor 30 until the actual value and the theoretical value are covered again.

FIG. 2 shows the section A-A and the primary design of the pendulum shafts 10 with the associated sensing arms 13 and their spatial position in the bicycle frame 4 and the cam disk 7. The view that is shown can be understood from the perspective of a bird's eye view. In the representation, the execution of the two pendulum arms 15 offset radially and down below are shown. The pendulum arm shafts 10 end in a bearing block, which for its part is rigidly connected to the bicycle frame 4.

In the representation, the mechanical linkage point of the gear mechanism elements 26 to the pendulum arms 15 is not visible.

Alternatively to FIG. 1, FIG. 3 shows the same gear mechanism, with the difference that not a pendulum arm, but rather an adjusting part 108 is movable, which cants the pendulum arm 104 that is not movable. In principle, when a workload occurs, the same process as in FIG. 1 takes place: An automatic canting of an adjusting part 108 in the stroke generator—in this case the pendulum arm 104—is produced by this load. In the representation, it can be seen that for each of these pendulum arms 104 that are not movable, a separate cam disk 105 is provided. This second cam disk 105 is shown in broken lines; the representation of the second pendulum arm 104 and the gear mechanism element 109 was eliminated since these parts are almost completely covered in the side view.

All other functions with respect to adjustment of the adjusting part 108, control of the adjusting Bowden cables, the cyclocomputer control, overload spring 35, etc., are covered by the variant according to FIG. 1.

FIG. 4 shows a pendulum arm 15 that is moved via Bowden cables 25, which in the position shown produces the highest possible cam on the gear mechanism element 26. The Bowden cable 25 takes up the pendulum arm 15 via the linkage 25 downward—the gear ratio thus decreases continuously. Conversely, the return spring 28 readjusts the pendulum arm 15 upward—if the latter is left behind by the link 25.

This return spring 28 that is shown exerts not only a return force on the pendulum arm 15, however, because of its geometrical shape and because of the suspension point on the pendulum arm shaft 10 and the pendulum arm 15. Rather, it also exerts a force that is directed against the return force of the free wheel 27—and thus also the gear mechanism element 26. As a result, in the return cycle 22, it is achieved that the pendulum arm 15 is actually released from the canting in the pendulum arm shaft 10 and optionally can be returned at any time during each return cycle 22.

FIG. 5 shows a pendulum arm 15 that is moved via a hydraulic cylinder/piston/connecting rod 24 and that in the position that is shown produces an average cam 20 on the gear mechanism element 26. The connecting rod takes the pendulum arm 15 down—the gear ratio is thus reduced continuously. Conversely, the return spring 28 readjusts the pendulum arm 15 upward again—if the latter is left behind by the link 25.

Also, this form of the return spring 28 exerts not only a return force on the pendulum arm 15 because of the suspension points on the pendulum arm shaft 10 and the pendulum arm 15. Rather, it also exerts a force that is directed against the return force of the free wheel 27—and thus also a gear mechanism element 26. As a result, it is achieved that the pendulum arm 15 in the return cycle is actually released from the canting in the pendulum arm shaft 10 and can be adjusted optionally at any time during each return cycle 22.

FIG. 6 shows with which simple linkage 41 of the linkage 25 a comparable “spring action” is achieved on the pendulum arm 15 that is to be adjusted. Such a spring buffer is necessary, since one of the two pendulum arms 15 in operation—thus during the work cycle 21—is locked in a fixed manner. If an adjustment is now performed with a locked pendulum arm 15, the linking means 42 of the linkage 41 moves promptly into the locked pendulum arm 15. If the work cycle 21 of the corresponding pendulum arm 15 is released again, the pendulum arm 15 opens its canting to the pendulum arm shaft 10, and the “missed adjustment path” is taken up—the linkage 41 automatically searches for the middle of the star 42 and is returned there.

In this FIG. 6, the arrangement of the heavy-load springs 35 can also be seen clearly. These heavy-load springs 35 quasi replace the “small gears” of a gear mechanism. They begin to expand starting from a specified heavy load, with which the complete length of stroke of the gear mechanism element 26 is no longer transferred to the free wheel 27. The lost length that is stored in the heavy-load spring 35 is relayed to the adjacent gear mechanism element 26 as an additional tensile force in the subsequent return cycle 22 via the slopes of the return cycle 22 to the cam disk 7. This offset discharge of the output by means of an intermediate storage in a metal spring 35 operates loss-free as is known.

FIG. 7 shows a special application of the invention, in which the adjustability of the pendulum arm 15 is completely eliminated, and now the load-dynamic stretchability of a heavy-load spring 35 is used for the adjustment of the gear ratio of the gear mechanism. To this end, a device was to be provided that allows an adjustment of the spring force from outside. In the representation that is shown, this adjustment of the spring force takes place with the assistance of a hydraulic cylinder 39. Other methods for adjusting the spring force, in any way or form whatsoever, are conceivable and thus do not exceed the object of the invention.

FIG. 8 shows the primary design of the entire free wheels 27 and the wheel hub 2 in sections. Because of the application of clamping-body free wheels 46, the free-wheel core 45 consists of a simple, rotationally symmetrical pipe. Even the two outside rings 47 with their pinion gears 48 that rotate in a form-fitting manner consist of simple rotationally symmetrical rings 47. This is highly advantageous in product technology. The wheel hub 2 is form-fitting along a common center axis to the free-wheel core 45 connected thereto. Free-wheel core 45 and wheel hub 2 are, for external completion, ball-mounted on the wheel shaft 49.

FIG. 9 shows that the cams 8 are rotating not at the same height but rather in each position 51 in which the pedals are in the OT/UT for the rider; the lower are 53. As a result, it is achieved that the UT/OT passage of the pedals 6 goes faster from some spots than those in which the pedals 6 can accommodate the maximum foot load 52. This device is advantageous for the rider, since its gear workload is also completely within a pedal rotation and is uniform. This generates massive advantages ergonomically.

### LEGEND

### 1. Input Shaft/Pedal Crankshaft

### 2. Output Shaft/Wheel Hub

### 3. Blade Wheel

4. Bicycle Frame with the Bearing Block for the Pendulum Arm Shaft 10

### 5. Bottom Bracket

### 6. Shoe

### 7. Cam Disk

### 8. Cam Disk

### 9. Entire Pendulum Arm (Including 13+14)

### 10. Pendulum Arm Shaft

### 11. Pendulum Arm Pass-Through

### 12. Pivot Bearing of the Pendulum Arm

### 13. Sensing Arm on the Pendulum Arm Shaft

### 14. Sensing Arm Rollers on the Cam Disk

### 15. Movable Pendulum Arms or Adjusting Parts

### 16. Variable Longitudinal Mass of the Pendulum Arm

### 17. Gear Mechanism Element—Suspension Point on the Pendulum Arm

### 18. Canting Noses in the Pendulum Arm Pass-Through

### 19. Sliding Flanks to Prevent a Canting in the Return Cycle

### 20. Pendulum Arm Adjustment Path

### 21. Work Cycle

### 22. Return Cycle

### 23. Longitudinal Axis of the Adjustment Path of the Pendulum Arm

### 24. Hydraulic or Pneumatic Adjusting Mechanism

### 25. Adjusting Bowden Cable for Individual Pendulum Arm 15

### 26. Flexible Gear Mechanism Element

27. Coupling Device that is Dependent on the Direction of Rotation

### 28. Pendulum Arm Overrunning Spring

### 29. Spring Element Between the Adjusting Cables 25

### 30. Electric Motor, Hydraulic or Pneumatic Adjusting Motor

### 31. Bicycle-Control Computer

### 32. Manually Operable Adjusting Lever

### 33. Pedal Frequency Sensor/Torque Sensor

### 34. Heart Rate Sensor/Other Sensors for Physiological Data

### 35. Load-Dynamic Spring Element (Load Spring)

### 36. Force Vector of the Return Spring for Releasing the Pendulum Arm Canting

37. Half Sine Length (½ Sine Angle) of a Cam Disk

### 38. Slide-in Hole for the Spring 28

### 39. Hydraulically Adjustable Element for Pretensioning the Spring 35

### 40. Return Spring for the Return Cycle (for Gear Mechanism Elements, Overrunning Couplings+Pendulum Arms)

### 41. Buffer Element/Star-Shaped Linkage

### 42. Linkage Point in the Center of the Star

### 43. Bowden Cable Sheath (End Point Fixed on the Vehicle)

### 44. Individual Bowden Cable of Adjusting Element 30 at the Linkage Point 42

### 45. Rotationally Symmetrical Free-Wheel Core

### 46. Clamping Body Free Wheel

47. Rotationally symmetrical Outside Rings Around Clamping Body Free Wheel

### 48. Pinion Gear or Toothed Belt Disk on the Outside Rings 47

### 49. Blade Wheel Axle

### 50. Longitudinal Axis of the Foot Pedal

51. Disadvantageous Angle Between the Rider's Leg under Load and the Longitudinal Axis of the Foot Pedal
52. Advantageous Angle Between the Rider's Leg under Load and the Longitudinal Axis of the Foot Pedal

### 53. Minimum Cam Height

### 54. Maximum Cam Height

### 103 Pendulum Arm Shafts

### 104 Pendulum Arm

### 105 Cam Disk

### 106 Cam Disk

### 108 Adjusting Part

### 109 Gear Mechanism Element

110 Couplings that are Dependent upon the Direction of Rotation

### 112 Suspension Point of the Gear Mechanism Element on the Adjusting Part

### 125 Foot Pedal

### 128 Bicycle Frame

### 130 Pendulum Arm Rollers

### 138 Length of Stroke of the Pendulum Arm

144 Center Position of the Pendulum Arm

1. Gear mechanism with a continuously variable gear ratio between an input shaft (1) and an output shaft (2), which has at least two pendulum arms (9) that are mounted to pivot around an axis (10) and that are offset into a uniform lifting motion (21) that alternately and mutually overlaps in the work cycles by the rotation of the input shaft (1) and the cam disks (7) that are connected to it in a form-fitting manner, and said arms convert by means of two adjusting parts (15) that can be moved along the pendulum arm adjustment path (20) or by means of two pendulum arms (15) that can be moved by the pendulum shaft (10) along the pendulum arm adjustment path (20) in the variable-length back-and-forth motion of the two gear mechanism elements (26), and this alternating motion is transmitted to the two couplings (27) that are dependent upon the direction of rotation, where it in turn converts into a continuous and uniform rotation of an output shaft (2), characterized in that each pendulum arm (15) under load is automatically canted for canting noses (18) in the pendulum arm pass-through (11) that are provided for this purpose.

2. Gear mechanism according to claim 1, wherein the adjusting parts (108) are canted non-positively on the respective pendulum arm (104) by the occurrence of a workload that is applied by the gear mechanism elements (109), and the adjusting parts (108) are immovably fixed dynamically and automatically to the respective pendulum arm (104) in such a way during the work cycle (140).

3. Gear mechanism according to claim 2, wherein the non-positive or form-fitting connection between adjusting part (108) and pendulum arm (104) is automatically released with the elimination of the workload during the return cycle (141) at least to the extent that the respective adjusting part (108) can move, if necessary, by means of a force far below the average tensile force that is transmitted by the adjusting part (108) and that is directed longitudinally to the longitudinal axis (142) of the pendulum arm.

4. Gear mechanism according to claim 3, wherein at the adjusting part (108), the suspension point (112) for the gear mechanism element (109)—in one of the two directions to the longitudinal axis (142) of the pendulum arm—is mounted far enough from any area (13) within which the adjusting part (108) is canted with the two tensile-force-loaded and opposing inside flanks (114) on the pendulum arm (104).

5. Gear mechanism according to claim 1, wherein a pendulum arm (15) is canted because of an occurring workload that is immovable relative to the resulting force that acts upon it to the canting noses (18) in the pendulum arm pass-through (11) that are provided in this respect.

6. Gear mechanism according to claim 1, wherein the bicycle-control computer (31) that collects data via sensors (33, 34) adjusts the gear mechanism in an automated manner automatically by the motor adjusting element (30) of the pendulum arm (15).

7. Gear mechanism according to claim 1, wherein the adjustment of the pendulum arm length (16) or the adjusting parts (108) is carried out by means of hydraulic, pneumatic, electric motor adjusting mechanisms (24) or by Bowden cables (25).

8. Gear mechanism according to claim 1, wherein a force vector (36) for releasing the canting between the pendulum arm pass-through (11) and the pendulum arm (15) is also produced by the pendulum arm overrunning spring.

9. Gear mechanism according to claim 1, wherein the two pendulum arms (11 or 104) are each located at a separate pendulum shaft (10 or 103) that are offset radially to one another by one-half sine length or one and one-half, two and one-half, etc., of sine lengths (37) of a cam disk (8 or 106).

10. Gear mechanism according to claim 1, wherein the two rollers (14 or 130) of the sensing arm (13) run together on a single cam disk (7 or 105).

11. Gear mechanism according to claim 1, wherein the cam disk (7 or 105) with its multiple cams (8 or 106), in the area in which the longitudinal axis (50) of the foot pedal forms a disadvantageous force vector angle (51) to the leg that is to bear the load, has the lowest cam height (53) and, conversely, in the area of the most advantageous force vector angle (52), the maximum cam height (54).

12. Gear mechanism according to claim 1, wherein the adjustment path (8) that cannot be embodied directly on the pendulum arm (15) or on the adjusting part (108), resulting during an adjustment process from the alternating adjusting locking function of the pendulum arm (15) or the adjusting parts (108), is stored intermediately in a mechanical buffer element (41), and this mechanical buffer element (41) consists of, for example, a star-shaped linkage, or the Bowden cable sheaths (43) of the Bowden cable links (25), which have a springy elasticity.

13. Gear mechanism according to claim 1, wherein a spring element (35), which extends reversibly and load-dynamically starting from the occurrence of a specific load, is interposed in each gear mechanism element (26 or 109).

14. Gear mechanism according to claim 13, wherein the respective load spring (35) is deformed load-dynamically in the work cycle (21), and the spring force that is stored in such a way is released again in an efficient way in the next return cycle (22) to support the driving of the vehicle.

15. Gear mechanism according to claim 14, wherein the load-dynamic spring element (35) in a variant according to the invention can be adjusted from outside in its spring force, and such a spring force adjustment is achieved by, for example, a hydraulic element (39) that increases or decreases the pretensioning of the spring element (35).

16. Gear mechanism according to claim 1, wherein the coupling device (27 or 110) that is dependent upon the direction of rotation has a rotationally symmetrical free-wheel core (45) on which two clamping body free wheels (46) are arranged, which are encased by a rotationally symmetrical ring (47).

17. Method for operating a gear mechanism with a continuously variable gear ratio between an input shaft (1) and an output shaft (2), which has at least two pendulum arms (9) that are mounted to pivot around an axis (10) and that are offset into a lifting motion (21) that alternately and mutually overlaps in the work cycles by the rotation of the input shaft (1) and the cam disks (7) that are connected to it in a form-fitting manner, and said arms convert by means of two adjusting parts (15) that can be moved along the pendulum arm adjustment path (20) or by means of two pendulum arms (15) that can be moved by the pendulum shaft (10) along the pendulum arm adjustment path (20), in the variable-length back-and-forth motion of the two gear mechanism elements (26), and this alternating motion is transmitted to the two couplings (27) that are dependent upon the direction of rotation, where it in turn converts into a continuous and uniform rotation of an output shaft (2), wherein for weight and size reduction of such a bicycle gear mechanism, each of the pendulum arms (9) within a foot pedal rotation is to activate several, but if possible many, deflections by several, but if possible many, cams (8) being provided on the driving cam disk(s) (7) on the pendulum arm(s) (9).

18. Method for operating a gear mechanism according to claim 16, wherein couplings (27 or 110) that are dependent upon the direction of rotation are used, which can handle the high shift frequencies that are specific to the invention of, under certain circumstances, up to about 50 Hz (50 opening and closing processes/second) and with a connecting path of less than 3° of the rotation of the outside rings (47) to the free-wheel core (45).

19. Method for operating a gear mechanism according to claim 16, wherein couplings (27 or 110) that are dependent upon the direction of rotation and that release the non-positive connection between the outside ring (47) and the free-wheel core (45) with no breaking force are used.

20. Method for operating a gear mechanism according to claim 16 claims 14 to 16, wherein clamping body free wheels (46) are used to handle the requirements that are necessary according to the invention on the couplings (27 or 110) that are dependent upon the direction of rotation.
